(19) United States
(12) Patent Application Publication
(10) Pub. No.: US 2026/0232102 A1
(43) Pub. Date: Aug. 13, 2026

(54) WEARABLE STRUCTURE

(71) Applicant: SPEED TECH CORPORATION, TAOYUAN CITY (TW)

(72) Inventors: Tsung Hua Chuang, TAOYUAN CITY (TW); Po Ching Chiang, TAOYUAN CITY (TW); Chia Sung Lin, TAOYUAN CITY (TW); Hsuan Ju Liu, TAOYUAN CITY (TW)

(21) Appl. No.: 19/341,337

(22) Filed: Sep. 26, 2025

(30) Foreign Application Priority Data
Feb. 7, 2025 (CN) 202520190630.3

(51) Int. Cl. A45F 5/00; F16M 11/08; F16M 13/04

(52) U.S. Cl. CPC A45F 5/1525; F16M 11/08; F16M 13/04; A45F 2005/008

(57) ABSTRACT

A wearable structure includes a first module and a second module. The first module is provided with a first body, the first body is provided with a seat part, and the seat part is provided with a through hole. The second module is provided with a second body, the second body is provided with a pivot part, and the pivot part is provided with a pivot shaft and a plurality of flexible hooks disposed on the peripheral side of the pivot shaft and encompassing the pivot shaft. The flexible hooks and the pivot shaft pass through the through hole, one end of each flexible hook is hooked around the opening of the through hole, and the sidewall of the pivot shaft contacts the wall of the through hole. The pivot part is rotatably disposed on the seat part, and the second body rotates with respect to the first body.

### CROSS-REFERENCE TO RELATED APPLICATIONS

This application claims the priority benefit of Chinese Patent Application Serial Number 2025201906303, filed on February 7th, 2025 the full disclosure of which is incorporated herein by reference.

### TECHNICAL FIELD OF THE INVENTION

The present disclosure relates to the technical field of wearable accessories and particularly relates to a wearable structure.

### DESCRIPTION OF THE PRIOR ART

In current technologies, a number of handheld electronic devices have been developed so far and have also provided various functions. The handheld electronic device which most people have is a mobile phone. Taking the mobile phone as an example, the mobile phone has numerous functions such as games provided with entertainments, a pedometer assisting in exercise measurement or GPS for map navigation in addition to basic communication. However, during the use of the said mobile phone, some functions don’t need to be kept using by holding the mobile phone. If being forced to use by holding the mobile phone, these functions which don’t need to be kept using by holding the mobile phone would cause difficulty and burdens on the use thereof instead. For example, if the handheld pedometer requires using during the exercise, swinging hands naturally during the exercise is impossible, and it causes extreme inconveniences in the use of the handheld pedometer. Alternatively, if performing the navigation by the mobile phone, a user on a bike needs to hold the mobile phone to see the map by one hand, and it is a troublesome problem in the use of the navigation.

### SUMMARY

A wearable structure is provided and includes a first module and a second module. The first module is provided with a first body, the first body is provided with a seat part, and the seat part is provided with a through hole. The second module is provided with a second body, the second body is provided with a pivot part, and the pivot part is provided with a pivot shaft and a plurality of flexible hooks. The flexible hooks are disposed on the peripheral side of the pivot shaft and encompass the pivot shaft, and the flexible hooks and the pivot shaft pass through the through hole. One end of each flexible hook is hooked around the opening of the through hole, and the sidewall of the pivot shaft contacts the wall of the through hole. The pivot part is rotatably disposed on the seat part, and the second body rotates with respect to the first body.

In one embodiment, the pivot shaft is provided with a plurality of contact sidewalls, and the contact sidewalls are separately arranged on the peripheral side of the pivot shaft and contact the wall of the through hole.

In one embodiment, there are accommodation recesses between the contact sidewalls of the pivot shaft, and the flexible hooks are respectively located within the accommodation recesses.

In one embodiment, the seat part of the first body further includes a stable indentation, the stable indentation is located on the peripheral side of the opening of the through hole, and one end of each flexible hook is hooked within the stable indentation.

In one embodiment, the second body is provided with a plurality of first hollow parts, each flexible hook is provided with a first extension body and a hook block, and one end of the first extension body is connected to the hook block. The first extension body extends outwards from the interior of the corresponding first hollow part of the second body, one end of the first extension body extends and passes through the through hole, and the hook block is hooked on the peripheral side of the opening of the through hole.

In one embodiment, the pivot part is provided with a plurality of flexible protrusions, the seat part is provided with a plurality of arc recesses, and one end of each flexible protrusion is embedded in the corresponding arc recess.

In one embodiment, the second body is provided with a plurality of second hollow parts, each flexible protrusion is provided with a second extension body and a circle protrusion, and the circle protrusion is disposed on one end of the second extension body. The second extension body extends outwards from the interior of the corresponding second hollow part of the second body, and the circle protrusion is embedded in the corresponding arc recess.

In one embodiment, the distances between the circle protrusions and the axle center of the pivot shaft of the pivot part are the same, each circle protrusion rotates with respect to the axle center of the pivot shaft, and each arc recess is located on the rotation path of the corresponding circle protrusion.

In one embodiment, there is an accommodation part on one side of the second body opposite to the pivot part, the accommodation part is provided with a frame body, and the frame body is located on the peripheral side of the second body and is configured to accommodate and fix an electronic device.

In one embodiment, the wearable structure further includes a connecting component, there is a connecting structure on the outer side of the first body, and the connecting component is fixedly connected to the connecting structure.

### BRIEF DESCRIPTION OF DRAWINGS

The accompanying drawings herein are provided to have a further understanding on the present disclosure and constitute one part of the present disclosure. The schematic embodiments of the present disclosure and the description thereof are used to explain the present disclosure instead of building inappropriate limitations on the present disclosure. In the drawings:

FIG. 1 is the schematic exploded diagram of the wearable structure in one embodiment of the present disclosure;

FIG. 2 is the schematic structural diagram of the wearable structure in one embodiment of the present disclosure;

FIG. 3 is another schematic structural diagram of the wearable structure in one embodiment of the present disclosure;

FIG. 4 is the enlarged diagram of the B region of FIG. 3;

FIG. 5 is the stereoscopic cross-section diagram of the A-A’ line of FIG. 2;

FIG. 6 is the enlarged diagram of the C region of FIG. 5;

FIG. 7 is the use state diagram of the wearable structure in one embodiment of the present disclosure; and

FIG. 8 is another use state diagram of the wearable structure in one embodiment of the present disclosure.

### DETAILED DESCRIPTION

The multiple embodiments of the present disclosure will be disclosed by the drawings as follows, and for precise explanation, the implementation details of the present disclosure will be explained in the following paragraphs. However, it should be understood that the implementation details of the present disclosure should not be construed as the restrictions of the present disclosure. In other words, in some embodiments of the present disclosure, the implementation details of the present disclosure are not essential. In addition, for simplifying the drawings, some well-known structures and modules in the drawings are depicted by simple illustrations. In the following embodiments, the same reference numbers in different drawings represent the same or similar modules.

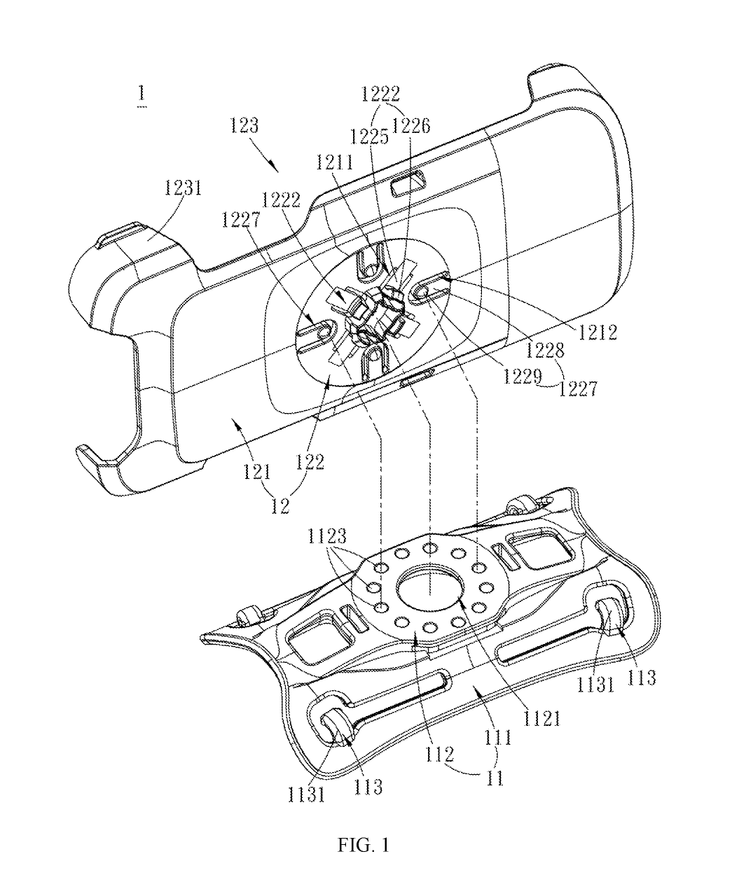

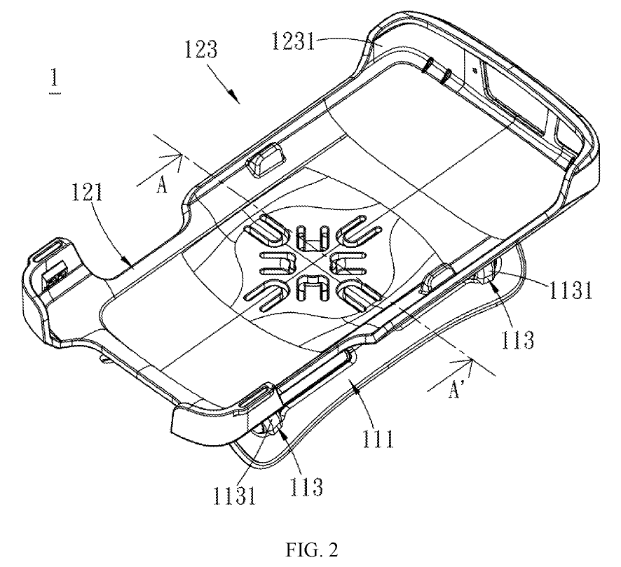

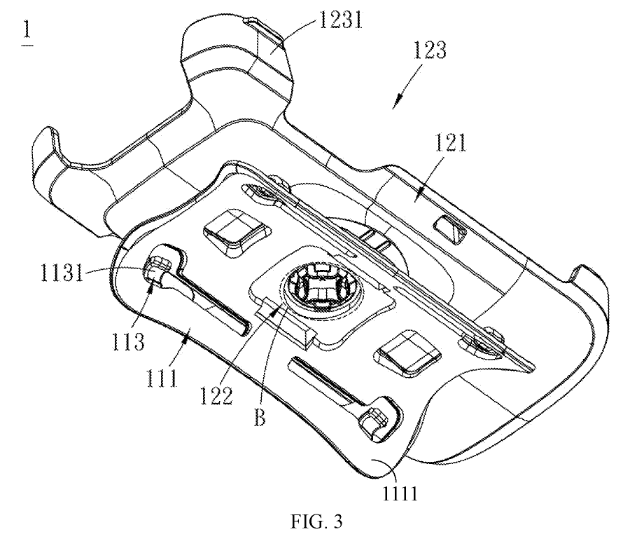

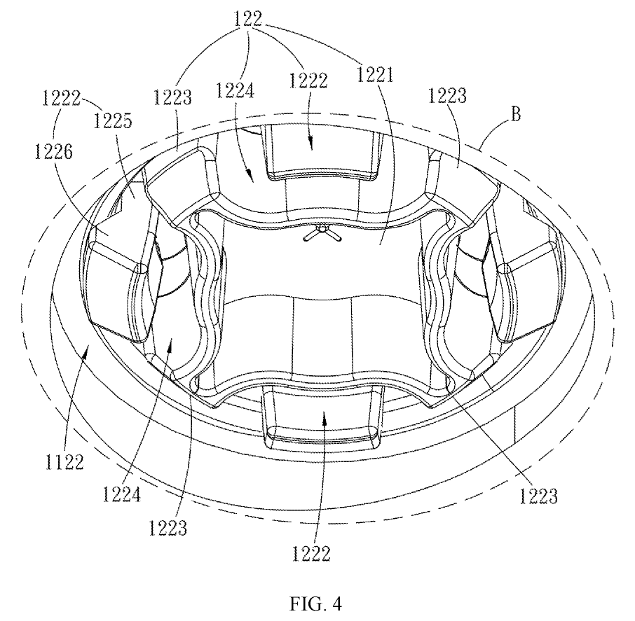

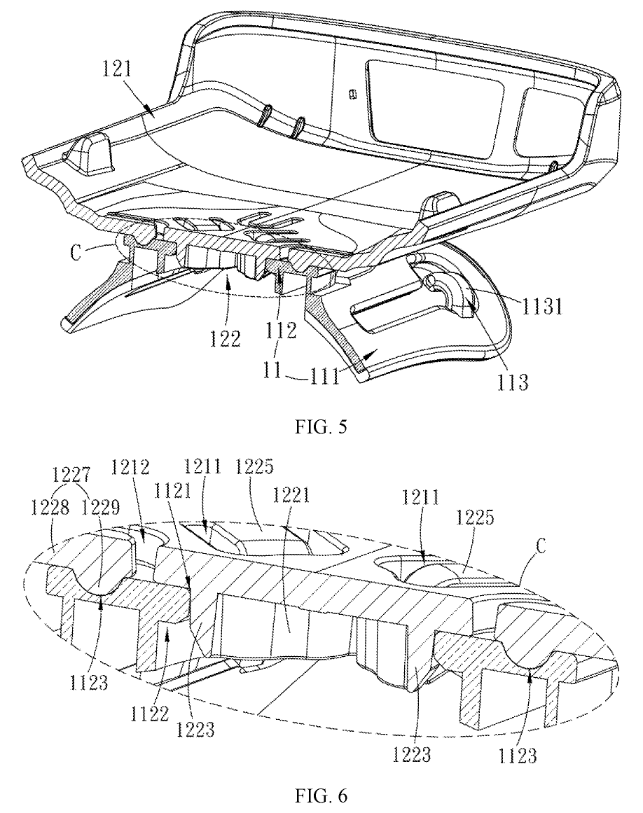

Please refer to FIGS. 1 to FIG. 6; FIG. 1 is the schematic exploded diagram of the wearable structure in one embodiment of the present disclosure, FIG. 2 is the schematic structural diagram of the wearable structure in one embodiment of the present disclosure, FIG. 3 is another schematic structural diagram of the wearable structure in one embodiment of the present disclosure, FIG. 4 is the enlarged diagram of the B region of FIG. 3, FIG. 5 is the stereoscopic cross-section diagram of the A-A’ line of FIGS. 2 and FIG. 6 is the enlarged diagram of the C region of FIG. 5. As shown in the figures, the present disclosure provides a wearable structure, and the wearable structure includes a first module 11 and a second module 12. The first module 11 is provided with a first body 111, the first body 111 is provided with a seat part 112, and the seat part 112 is provided with a through hole 1121. The second module 12 is provided with a second body 121, the second body 121 is provided with a pivot part 122, and the pivot part 122 is provided with a pivot shaft 1221 and a plurality of flexible hooks 1222. The flexible hooks 1222 are disposed on the peripheral side of the pivot shaft 1221 and encompass the pivot shaft 1221, and the flexible hooks 1222 and the pivot shaft 1221 pass through the through hole 1121. One end of each flexible hook 1222 is hooked around the opening of the through hole 1121, and the sidewall of the pivot shaft 1221 contacts the wall of the through hole 121. The pivot part 122 is rotatably disposed on the seat part 112, and the second body 121 rotates with respect to the first body 111.

According to the aforementioned descriptions, in the present embodiment, the pivot shaft 1221 of the pivot part 122 is provided with a plurality of contact sidewalls 1223. The contact sidewalls 1223 are separately arranged on the peripheral side of the pivot shaft 1221 and contact the wall of the through hole 121. Hence, the pivot shaft 1221 is relatively fixed within the through hole 1121. When the second body 121 rotates with respect to the first body 111, the contact sidewalls 1223 of the pivot shaft 1221 continue contacting the wall of the through hole 121 to rotate, and thus, the rotation center position of the second body 121 with respect to the first body 111 can be maintained by the pivot shaft 1221.

In addition, there are accommodation recesses 1224 between the contact sidewalls 1223 of the pivot shaft 1221, and the flexible hooks 1222 are respectively located within the accommodation recesses 1224. Each flexible hook 1222 is provided with a first extension body 1225 and a hook block 1226, and one end of the first extension body 1225 is connected to the hook block 1226. The second body 121 is provided with a plurality of first hollow parts 1211. The first extension body 1225 extends outwards from the interior of the corresponding first hollow part 1211 of the second body 121, one end of the first extension body 1225 extends and passes through the through hole 1121 of the first body 111, and the hook block 1226 extends to the peripheral side of the through hole 1121 and is thus hooked on the peripheral side of the opening of the through hole 1121. There are the first hollow parts 1211 on two sides of the first extension body 1225 so that the fixed connection scope of the first extension body 1225 subject to the second body 121 is less, and thus, the bendable extent of the first extension body 1225 is greater.

In addition, the seat part 112 of the first body 111 further includes a stable indentation 1122, the stable indentation 1122 is located on the peripheral side of the opening of the through hole 1121, and the hook blocks 1226 of the flexible hooks 1222 are hooked within the stable indentation 1122. In other words, the hook blocks 1226 are accommodated by the stable indentation 1122, and thus, the pivot part 122 would not pass through the bottom surface of the first body 111. When the arm of the user wears the wearable structure 1, the bottom surface of the first body 111 of the first module 11 covers the arm of the user, and the user would not feel an obvious foreign body sensation on the bottom surface of the first body 111.

Please refer to FIG. 6 again. The pivot part 122 is provided with a plurality of flexible protrusions 1227, the seat part 112 is provided with a plurality of arc recesses 1123, and the arc recesses 1123 symmetric about the through hole 1121. One end of each flexible protrusion 1227 is embedded in the corresponding arc recess 1123. Each flexible protrusion 1227 is provided with a second extension body 1228 and a circle protrusion 1229, and the circle protrusion 1229 is disposed on one end of the second extension body 1228. The number of the arc recesses 1123 is different from the number of the circle protrusions 1229. The second body 121 is provided with a plurality of second hollow parts 1212, the second extension body 1228 extends outwards from the interior of the corresponding second hollow part 1212 of the second body 121, and the circle protrusion 1229 is embedded in the corresponding arc recess 1123. There are the second hollow parts 1211 on two sides of the second extension body 1228 so that the fixed connection scope of the second extension body 1228 subject to the second body 121 is less, and thus, the bendable extent of the second extension body 1228 is greater. The second hollow parts 1212 are separate from the first hollow parts 1211.

In addition, the distances between the circle protrusions 1229 and the axle center of the pivot shaft 1221 of the pivot part 122 are the same, each circle protrusion 1229 rotates with respect to the axle center of the pivot shaft 1221, and each arc recess is located on the rotation path of the corresponding circle protrusion 1229. Moreover, the surface of the circle protrusion 1229 and the surface of the arc recess 1123 are respectively designed as an arc convex surface and an arc concave surface to help the circle protrusion 1229 to be easier to slide out of the arc recess 1123. Thus, when the second body 121 rotates with respect to the first body 111, the circle protrusion 1229 of the flexible protrusion 1227 of the second body 121 may slide out of or in the arc recess 1123 of the first body 111. On one hand, the fixed rotation angle of the second body 121 with respect to the first body 111 is provided; on the other hand, the grainy sound and feeling during the rotation by the user are provided.

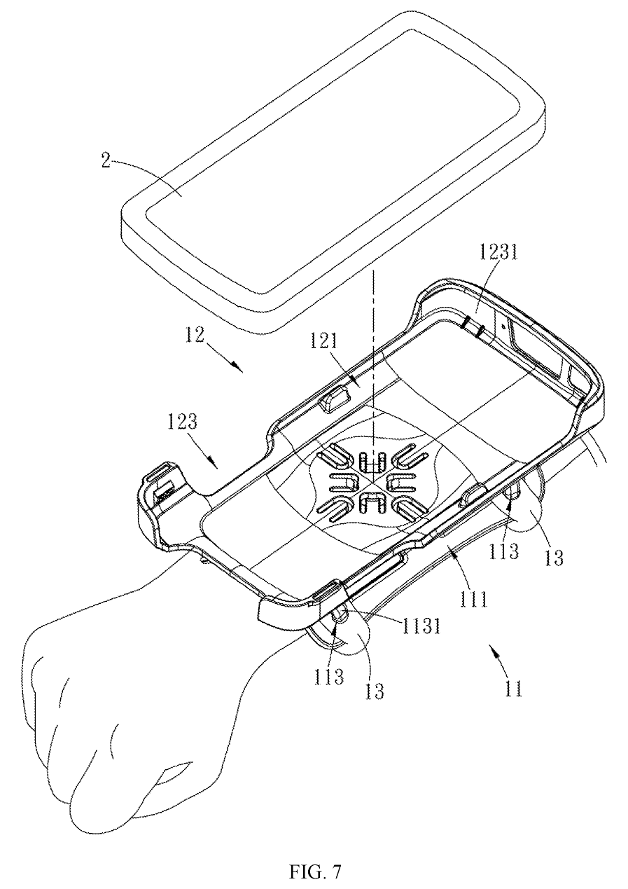

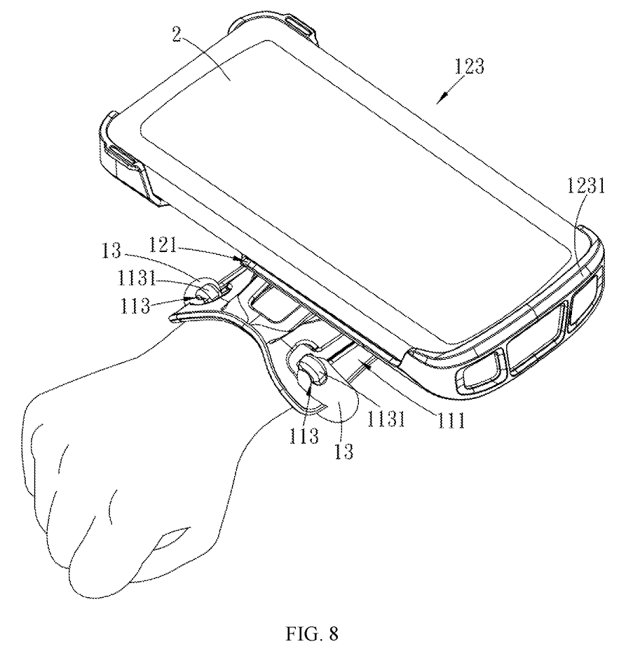

Please refer to FIGS. 7 and FIG. 8, which are the use state diagram of the wearable structure in one embodiment of the present disclosure and another use state diagram of the wearable structure in one embodiment of the present disclosure. As shown in the figures, in the present embodiment, there is an accommodation part 123 on one side of the second body 121 opposite to the pivot part 122, the accommodation part 123 is provided with a frame body 1231, and the frame body 1231 is located on the peripheral side of the second body 121 and is configured to accommodate and fix an electronic device 2. The frame body 1231 is provided with a plurality of auxiliary openings which expose the charging port, the volume button, and the audio port of the electronic device 2. In addition, the wearable structure 1 further includes a connecting component 13, there is a connecting structure 113 on the outer side of the first body 111, and two ends of the connecting component 13 are respectively connected to and fixed to the connecting structure 113. The bottom surface of the first body 111 is an accommodation surface structure 1111 with a radian, the connecting structure 113 has four anchors 1131 which are respectively located on the four corners of the first body 111. The connecting component 13 may be a fixed strap. Thus, two ends of the connecting component 13 may be twisted and fixed on the connecting structure 113. The accommodation part 123 in the present embodiment is configured to mount the electronic device 2 and may be adjusted according to the requirements of the user.

Please refer to FIGS. 1, FIG. 7 and FIG. 8 again. In the present embodiment, the user mounts the electronic device 2 on the accommodation part 123 of the second body 121, and the second body 121 is mounted on the first body 111. The pivot part 122 of the second body 121 corresponds to the seat part 112 of the first body 111, and the pivot part 122 of the second body 121 is vertically embedded in the through hole 1121 of the seat part 112 of the first body 111. Hence, the contact sidewalls 1223 of the pivot shaft 1221 contacts the wall of the through hole 1121, and the hook blocks 1226 of the flexible hooks 1222 are hooked within the stable indentation 1122 of the through hole 1121. Thus, the vertical direction of the hook block 1226 is restrained by the opening of the through hole 1121 to limit the vertical movements of the second body 121 with respect to the first body 111. At present, the circle protrusion 1229 of one end of each flexible protrusion 1227 is embedded in the corresponding arc recess 1123. Thus, the rotation angle of the second body 121 with respect to the first body 111 is fixed. At present, the grainy sound and feeling when the user rotates the second body 121 and the first body 111 are provided.

In the present embodiment, the first body 111 of the first module 11 is mounted on the arm of the user, and the accommodation surface structure 1111 of the first body 111 has the surface of which the radian approaches the radian of the arm so that the first body 11 can be stably attached to the arm. Two ends of the connecting component 13 are twisted on the connecting structure 113, and thus, the first module 11 is fixed on the arm of the user by the connecting component 13.

In view of the above descriptions, the wearable structure provided by the present disclosure may facilitate the handheld electronic device to be worn on the arm of the user by the mounting way of the first module and the second module, and the requirements of using the handheld electronic device may be thus avoided. The handheld electronic device may be mounted on the second module, the first module is worn on the arm of the user, and the second module may be mounted on the first module. Thus, the handheld electronic device on the second module is worn on the arm of the user by the first module and is able to rotate the usage direction of a screen with respect to the first module. In addition, the mounting and the dismantling of the second module with respect to the first module may be all completed by the single hand of the user to improve the convenience of using the wearable structure by the user.

Although the present disclosure has described and demonstrated numerous preferred embodiments, as described above, it should be appreciated that the present disclosure may not be limited to the form disclosed herein and may be applied to various other combinations, modifications and environments instead of being regarded as the exclusion of the other embodiments, and the present disclosure can be altered or modified by the above teaching or the related technologies or knowledge in the scope built by the present disclosure. The modifications and the variations made by a person skilled in the art without departing from the spirit of the present disclosure should be considered within the scope of the protection of the present disclosure as limited solely by the appended claims.

What is claimed is:

1. A wearable structure comprising:
a first module provided with a first body, wherein the first body is provided with a seat part, and the seat part is provided with a through hole; and
a second module provided with a second body, wherein the second body is provided with a pivot part, the pivot part is provided with a pivot shaft and a plurality of flexible hooks disposed on a peripheral side of the pivot shaft and encompassing the pivot shaft, the flexible hooks and the pivot shaft pass through the through hole, one end of each of the flexible hooks is hooked around an opening of the through hole, and a sidewall of the pivot shaft contacts a wall of the through hole;
wherein the pivot part is rotatably disposed on the seat part, and the second body rotates with respect to the first body.

2. The wearable structure according to claim 1, wherein the pivot shaft is provided with a plurality of contact sidewalls, and the contact sidewalls are separately arranged on the peripheral side of the pivot shaft and contact the wall of the through hole.

3. The wearable structure according to claim 2, wherein there are accommodation recesses between the contact sidewalls of the pivot shaft, and the flexible hooks are respectively located within the accommodation recesses.

4. The wearable structure according to claim 1, wherein the seat part of the first body further comprises a stable indentation located on a peripheral side of the opening of the through hole, and the one end of each of the flexible hooks is hooked within the stable indentation.

5. The wearable structure according to claim 1, wherein the second body is provided with a plurality of first hollow parts, each of the flexible hooks is provided with a first extension body and a hook block, and one end of the first extension body is connected to the hook block.

6. The wearable structure according to claim 5, wherein the first extension body extends outwards from an interior of the corresponding first hollow part of the second body, the one end of the first extension body extends and passes through the through hole, and the hook block is hooked on a peripheral side of the opening of the through hole.

7. The wearable structure according to claim 6, wherein the pivot part is provided with a plurality of flexible protrusions, the seat part is provided with a plurality of arc recesses, and one end of each of the flexible protrusions is embedded in the corresponding arc recess.

8. The wearable structure according to claim 7, wherein the second body is provided with a plurality of second hollow parts, and each of the flexible protrusions is provided with a second extension body and a circle protrusion disposed on one end of the second extension body; the second extension body extends outwards from an interior of the corresponding second hollow part of the second body, and the circle protrusion is embedded in the corresponding arc recess.

9. The wearable structure according to claim 8, wherein the second hollow parts are separate from the first hollow parts.

10. The wearable structure according to claim 8, wherein the arc recesses are symmetric about the through hole, and the number of the arc recesses is different from the number of the circle protrusions.

11. The wearable structure according to claim 8, wherein distances between the circle protrusions and an axle center of the pivot shaft of the pivot part are the same, each of the circle protrusions rotates with respect to the axle center of the pivot shaft, and each of the arc recesses is located on a rotation path of the corresponding circle protrusion.

12. The wearable structure according to claim 1, wherein there is an accommodation part on one side of the second body opposite to the pivot part, the accommodation part is provided with a frame body, and the frame body is located on a peripheral side of the second body and is configured to accommodate and fix an electronic device.

13. The wearable structure according to claim 1, further comprising a connecting component, and there is a connecting structure on an outer side of the first body, and the connecting component is fixedly connected to the connecting structure.

14. A wearable structure comprising:
a first module provided with a first body, wherein the first body is provided with a seat part, and the seat part is provided with a through hole; and
a second module provided with a second body, wherein the second body is provided with a pivot part, the pivot part is provided with a pivot shaft and a plurality of flexible hooks disposed on a peripheral side of the pivot shaft and encompassing the pivot shaft, the flexible hooks and the pivot shaft pass through the through hole, one end of each of the flexible hooks is hooked around an opening of the through hole, and a sidewall of the pivot shaft contacts a wall of the through hole;
wherein the pivot part is rotatably disposed on the seat part, and the second body rotates with respect to the first body;
wherein there is an accommodation part on one side of the second body opposite to the pivot part, the accommodation part is provided with a frame body, and the frame body is located on a peripheral side of the second body and is configured to accommodate and fix an electronic device.

15. The wearable structure according to claim 14, wherein the frame body is provided with a plurality of auxiliary openings which expose a charging port, a volume button, and an audio port of the electronic device.
